(19) United States
(12) Patent Application Publication
(10) Pub. No.: US 2013/0191535 A1
(43) Pub. Date: Jul. 25, 2013

(54) METHOD AND SYSTEM FOR CLOUD-BASED MEDIA ADAPTATION AND TRANSCODING SERVICE

(71) Applicant: Bhumip Khasnabish, Lexington, MA (US)

(72) Inventor: Bhumip Khasnabish, Lexington, MA (US)

(73) Assignee: ZTE (USA) INC, Richardson, TX (US)

(21) Appl. No.: 13/807,214

(22) PCT Filed: Jun. 29, 2011
(86) PCT No.: PCT/US11/42349

§ 371 Date: Apr. 11, 2013

Related U.S. Application Data
(60) Provisional application No. 61/359,602, filed on Jun. 29, 2010.

(51) Int. Cl. H04L 29/06

(52) U.S. Cl. CPC H04L 65/1069; H04L 43/0876
USPC 709/224; 709/227

(57) ABSTRACT

A system for establishing a communication session between an originating device and a terminating device using at least one media adaptation and transcoding service (MATS) host comprises at least one computing device which searches a domain associated with the at least one originating and terminating device, for the at least one MATS host. The at least one MATS host comprises a resource configured to establish a communication session between the originating device and the terminating device. If at least one MATS host is available in the domain, the at least one computing device establishes the communication session between the originating device and the terminating device by using the resource of the at least one MATS host. The used resource is monitored during the established communication session.

### PRIORITY

Priority is claimed to Provisional Application No. 61/359,602 filed Jun. 29, 2010, the disclosure of which is incorporated herein by reference in its entirety.

### FIELD OF THE INVENTION

The field of the present invention is media adaptation and transcoding in wired and mobile communication environments.

### BACKGROUND

In traditional communication systems, when originating and terminating endpoints cannot agree to use the same codec or the same rendering device at both ends, a session establishment request is abandoned. If the communication session needs to be established, to fulfill the session establishment request, the endpoints or service providers need to be changed. The new mutually agreed upon endpoints need to be able to support the type and configuration of the same set of codecs or transcoders so that the media can be rendered for consumption by users. This may not always be practical or cost-effective.

Alternatively, a new set of service providers can be utilized. At least one of these new service providers needs to support the required media adaptation and transcoding servers in a network. The purpose of the new service provider is to help the originating and terminating endpoints (with dissimilar codecs and/or rendering devices) establish a valid and useful communication session.

### SUMMARY OF THE INVENTION

Aspects of the present invention are drawn to systems and methods for establishing a communication session between at least one originating and terminating device using at least one media adaptation and transcoding service (MATS) host.

In a first aspect, at least one computing device searches a domain associated with the originating device and the terminating device, for the at least one MATS host. The at least one MATS host comprises a resource configured to establish a communication session between the originating device and the terminating device. If the at least one MATS host is available in the domain, the at least one computing device establishes the communication session between the originating device and the terminating device by using the resource of the at least one MATS host. The used resource may be monitored during the established communication session. Parameters associated with the used resource may also be recorded.

In a second aspect, the at least one computing device searches a cloud-based network to discover the at least one MATS host. Then a communication session is established between the originating device and the terminating device by using the resource of the at least one MATS host.

Any of the above aspects may be implemented alone or in combination. Additional aspects and advantages of the improvements will appear from the description of the preferred embodiment.

### BRIEF DESCRIPTION OF THE DRAWINGS

Aspects of the present invention are illustrated by way of the accompanying drawings, in which:

FIG. 1 is a schematic diagram illustrating a typical point of presence (POP) or host for implementing media adaptation and transcoding services (MATS);

FIG. 2 is a schematic diagram illustrating connectivity of the MATS hosts through Gigabit Ethernet (GbE), Ethernet over SONET (EoS) or other higher speed interfaces;

FIG. 3 is a signaling diagram illustrating devices with built-in support for disparate media adaptation and coding establishing a session for exchanging comprehensible media with support of a cloud-based MATS host.

### DETAILED DESCRIPTION OF THE PREFERRED EMBODIMENTS

Aspects of the present invention are directed to a mechanism for discovering a MATS host or server in a private could or a public cloud (e.g., the Internet), and to utilization of that server for the duration of a session, without imposing a burden of finding conforming endpoints or service providers.

Aspects of the present invention are directed to a mechanism for discovering a MATS host or server in a private could or a public cloud (e.g., the Internet), and to the utilization of that server for the duration of a session, without imposing the burden of finding the conforming endpoints or service providers. Therefore, aspects of the present invention provide a cost-effective solution to the media adaptation and transcoding problems. If media-adaptation and transcoding is required, that is, if the originating and terminating endpoints need to use different codec and rendering device for the same session, then an attempt is made to locate a MATS host within the originating or terminating endpoint domain. If a feasible MATS host is found within the originating or terminating endpoint domain, then the media-adaptation and transcoding requirements are fulfilled and the session establishment request is fulfilled.

If a feasible MATS host is not found, then a MATS host is discovered by searching various locations. For example, a search of a pre-populated table with a list of domains is performed. A search of a list of peer carriers or service providers, local and global MATS providers, the Web, and/or any other domains may also be performed. Upon discovery, the search is narrowed down to one or two preferred MATS host(s).

Thereafter, resources in the MATS host(s) may be reserved. For example, the signal processing resources, the codec-specific resources, the media-specific resources, the memory resources, the CPU cycle, and other resources that may be needed are reserved.

The reserved resources are then used and monitored. Occurrence and frequency of a threshold-crossing event of the resource utilization is noted. The utilization of the MATS resources, buffer underflow and overflow events (media continuity), the network level impairments (delay, jitter, loss, etc.) that adversely impact service quality, the processor level impairments that adversely impact service quality, and any other resources that are being utilized are also monitored.

The quality and availability of the MATS resources for session duration are maintained. Any standby or secondary resources that may be needed in order to maintain quality of service (QoS) and quality of experience (QoE), which should be at least as good as the non-MATS scenario, are activated. Alternative routing and recover mechanisms to prevent underflow and overflow are also activated. Any other standby resources in order to maintain service and quality continuity are also activated.

Various other information is then recorded. For example, the start and end times of resources utilization, the details of resources utilization (for private utilization), the auditable information parts of the resources utilization, the verifiable information parts of the resources utilization, the public information parts of the resources utilization, and any other events and occurrences that may be worth noting are recorded.

Releasing the reserved resources includes releasing all unused private and public (memory) space that was reserved for recording and verification and confirmation for audit trail (may need third party) are released.

Aspects of the present invention, therefore, provide a system and a mechanism having features and advantages of providing media adaptation and transcoding services in a cost-effective fashion (for both end user and service provider) without owning the infrastructure as discussed above.

Aspects of the present invention are also directed to a system for communicating information, sound, or images from an initiating device to a terminating device where media adaptation and transcoding can render encoded signal inputs from an initiating device recognizable and useful at the terminating device. This system includes a communication initiated device employing a first media format and terminating device for receiving communications employing a different media format such that adaptation and transcoding is required to recognize and utilize transmitted data, information, sound, or images. The initiating and terminating devices are in communication with each other and with a host server to implement media adaptation and transcoding services. The host server is adapted or programmed to search the cloud for hosts to decode signal inputs from the communication initiating device at the communication termination device. The communication termination device or receiving device is, for example, a wireless telephone, wired telephone, television, watch, radio, computer, software agent or client, or a mixed functional device.

The system can tolerate disasters and outages while maintaining service continuity with a desired level of security and service quality. Aspects of the present invention are applicable to both software and hardware clients irrespective of whether a software client is virtualized or not. A software client, by way of non-limiting example only, may refer to a Skype software client that can run on a mobile phone, a laptop, or desktop PC. A virtualized client, also by way of non-limiting example, refers to an instance of a client that is implemented by utilizing virtualized instances of the resources.

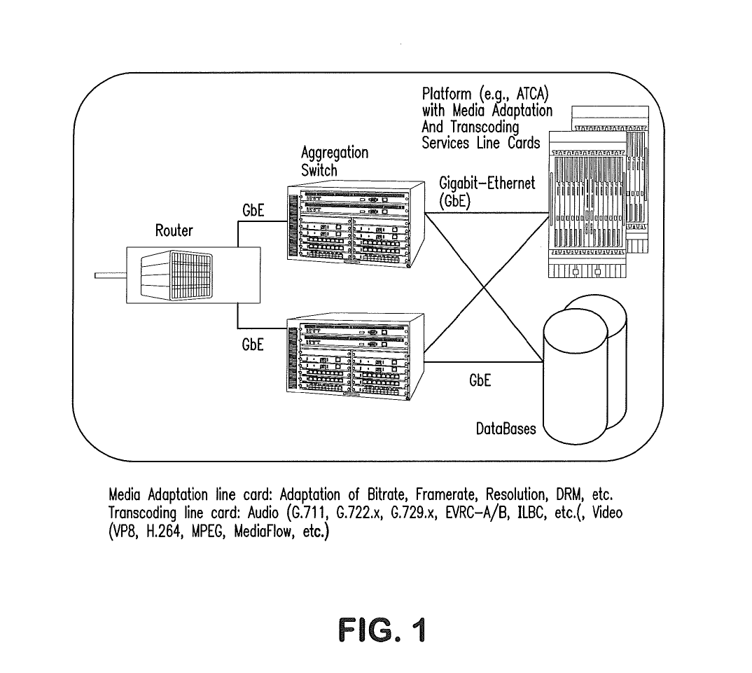

FIG. 1 illustrates a schematic diagram of a typical point of presence (“POP”) or host for implementing media adaptation and transcoding services (“MATS”). An edge router provides physical connectivity/access to resources in the POP, and implements, via logical interfaces, a service access and interface point (“SAIP”) which may contain a virtual proxy. Aggregation switches and redundant cross connections provide the availability and reliability. The redundant cross connections use simple GbE links or higher-speed (e.g. 10 GbE or 100 GbE) links. Databases provide information for resource assignment and also support monitoring, billing, tracing, and diagnosis functions. An advanced telecommunications computing architecture (“ATCA”) platform hosts blades or line cards that provide media adaptation and transcoding services for audio, video, and other media applications. It is possible to configure these blades in 1 for N and/or 1 for 1 configurations to maintain service and quality continuity.

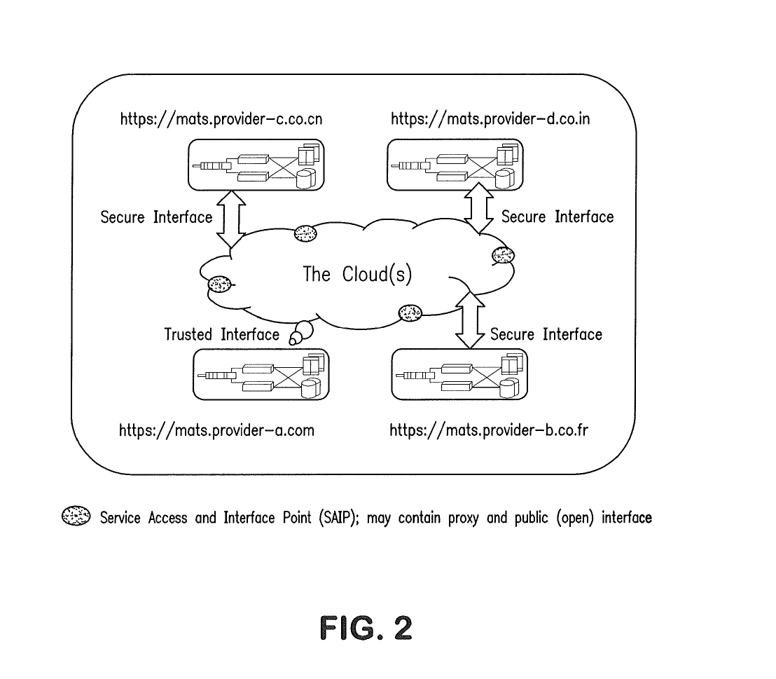

FIG. 2 illustrates connectivity of the MATS hosts through GbE, Ethernet over SONET (EoS) or other higher speed interfaces. It is possible to identify the MATS hosts via URLs, e.g., http://mats.provider-a.com, https://mats.provider-c.co.cn, and so on.

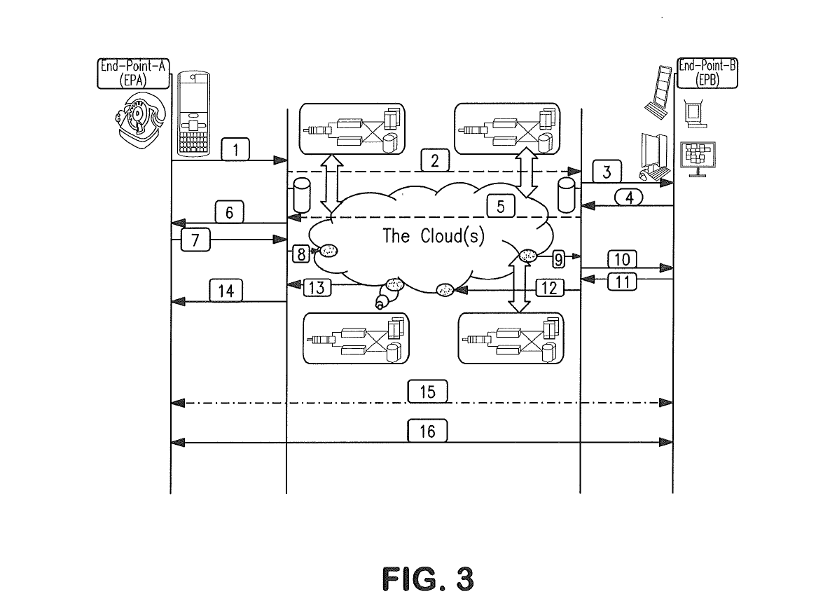

FIG. 3 is a signaling diagram illustrating an example of devices with built-in support for disparate media adaptation and coding establishing a session for exchanging comprehensible media with support of a clouds-based MATS host.

In Step 1, an endpoint A sends a session setup request message to an access network server requesting a specific type of media/device and coding option. In Step 2, the access network server dispatches the session setup request to a server of the terminating network via the service provider's network.

In Step 3, the terminating network server sends a receipt of the session setup request to endpoint B. In Step 4, endpoint B responds by sending a request to the terminating network server that the session setup needs a media adaptation and transcoding service. In Step 5, the terminating network server sends the request for a media adaptation and transcoding service to the access network server.

In Step 6, the access network server sends a rejection of the session setup request along with the media adaptation and transcoding service requirements to endpoint A. In Step 7, endpoint A sends a new session setup request with a specific type of media/device and coding support to the access network server. In Step 8, the access network server sends information about the new session setup request, where the information includes MATS requirements through a service access and interface point (“SAIP”) of the public and/or public clouds.

In Step 9, the public and/or public clouds locate a MATS server for the session, and communicate the location and MATS resources information to the terminating network server through another SAIP of the public and/or public clouds. This includes searching private and public databases and the Internet, for compatible media adaptation and transcoding host(s) and sources comprise pre-populated lists of domains, lists of communication service providers, lists of local and global media adaptation and transcoding providers, and other domains as appropriate. A preferred method of identifying compatible media adaptation and transcoding hosts is by distinctive URLs, e.g., https://mats.provider-a.com; https://mats.provider-b.com; etc. Preferably, resources discovered through this searching are reserved, and include digital and analog signal processing, codecs-specific, media-specific, memory, and CPU cycle, and others as required.

In Step 10, the terminating network server sends a receipt of the session setup request, with MATS location and resources information for use in the media path, to the called endpoint B.

In Step 11, endpoint B accepts the session setup request along with approval to utilize the MATS host in the media path, as needed.

In Step 12, the session setup and MATS service acceptance notification is communicated to the public and/or public clouds via the SAIP to enable reservation of the resources. The resources' need may be based upon several items, which are preferably monitored. These items include buffer underflow and overflow events, network level impairments including delays, jitter, and (stream or burst) loss that may adversely impact service quality.

Preferably, parameters are recorded during the communication session including start and end times of resource utilization, details of resources utilized, auditable information parts of resource utilization, verifiable information parts of resources utilized, public information parts of resources utilized, and other noteworthy occurrences.

In Step 13, the SAIP of the public and/or public clouds informs the access network server about the acceptance of the session setup and MATS service. In Step 14, the access network server communicates the session setup and MATS service acceptance notification to the calling endpoint A.

In Step 15, the signaling message exchange with the agreement to utilize a media-path MATS host from the clouds is now complete. In Step 16, media path establishment with in-path MATS from the clouds is now complete.

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method for establishing a communication session between an originating device and a terminating device using at least one media adaptation and transcoding service (MATS) host, the method comprising:
searching, by at least one computing device, a domain associated with the originating device and the terminating device, for the at least one MATS host, wherein the at least one MATS host comprises a resource configured to establish a communication session between the originating device and the terminating device; and
in response to determining that the at least one MATS host is available in the domain, establishing the communication session between the originating device and the terminating device by using the resource of the at least one MATS host.

2. The method of claim 1 further comprising:
monitoring the used resource during the established communication session; and
recording parameters associated with the used resource during the established communication session.

3. The method of claim 2 wherein the recorded parameters comprise one or more of:
a type of the resource utilized; and
a duration of utilization of the used resource.

4. The method of claim 1 in response to determining that the at least one MATS host is not available within the domain of the originating device and the terminating device, searching, by the at least one computing device, a cloud-based network to discover the at least one MATS host; and

5. The method of claim 1, further comprising:
releasing the used resource to end the communication session.

6. The method of claim 1 wherein the resource comprises one or more of a signal processing resource, a codec-specific resource, a media-specific resource, a memory resource, and a CPU cycle.

7. The method of claim 1 further comprising:
searching at least one database for the at least one MATS host.

8. The method of claim 7 wherein the at least one database comprises one or more lists of:
domains,
communication service providers, or
local and global media and transcoding providers.

9. A system for establishing a communication session between an originating device and a terminating device using at least one media adaptation and transcoding service (MATS) host, the system comprising:
at least one computing device configured to:
search a domain associated with the originating device and the terminating device, for the at least one MATS host, wherein the at least one MATS host comprises a resource configured to establish a communication session between the originating device and the terminating device; and
in response to determining that the at least one MATS host is available in the domain, establish the communication session between the originating device and the terminating device by using the resource of the at least one MATS host.

10. The system of claim 9, wherein the at least one computing device is further configured to:
monitor the used resource during the established communication session; and
record parameters associated with the used resource during the established communication session.

11. The system of claim 10 wherein the recorded parameters comprise one or more of:
a type of the resource utilized; and
an duration of utilization of the used resource.

12. The system of claim 9 wherein, in response to determining that the at least one MATS host is not available within the domain of the originating device and the terminating device, the at least one computing device is further configured to search a cloud-based network to discover the at least one MATS host.

13. The system of claim 9 wherein the at least one computing device is further configured to release the used resource to end the communication session.

14. The system of claim 9 wherein the resource comprises one or more of a signal processing resource, a codec-specific resource, a media-specific resource, a memory resource, and a CPU cycle.

15. The system of claim 9 wherein the at least one computing device is further configured to:
search at least one database for the at least one MATS host.

16. The system of claim 15 wherein the at least one database comprises one or more of pre-populated lists of:
domains,
communication service providers, or
local and global media and transcoding providers.

17. A system for establishing a communication session between an originating device and a terminating device using at least one media adaptation and transcoding service (MATS) host, the system comprising:
means for searching a domain associated with the originating device and the terminating device, for the at least one MATS host, wherein the at least one MATS host comprises a resource configured to establish a communication session between the originating device and the terminating device; and
in response to determining that the at least one MATS host is available in the domain, means for establishing the communication session between the originating device and the terminating device by using the resource of the at least one MATS host.

18. The system of claim 17, further comprising:
means for monitoring the used resource during the established communication session; and
means for recording parameters associated with the used resource during the established communication session

19. The system of claim 18 wherein the recorded parameters comprise one or more of:
a type of the resource utilized; and
an duration of utilization of the used resource.

20. The system of claim 17 further comprising:
in response to determining that the at least one MATS host is not available within the domain of the at least one originating and terminating devices, means for searching a cloud-based network to discover the at least one MATS host.

21. The system of claim 17, further comprising:
means for releasing the used resource by ending the communication session.

22. The system of claim 17 wherein the resource comprises one or more of a signal processing resource, a codec-specific resource, a media-specific resource, a memory resource, and a CPU cycle.

23. The system of claim 17 further comprising:
means for searching at least one database for the at least one MATS host.

24. The system of claim 23 wherein the at least one database comprises one or more pre-populated lists of:
domains,
communication service providers, or
local and global media and transcoding providers.
